(19) United States
(12) Patent Application Publication
(10) Pub. No.: US 2022/0365293 A1
(43) Pub. Date: Nov. 17, 2022

(54) INTEGRATED ACCURATE MOLDED LENS ON SURFACE EMITTING/ABSORBING ELECTRO-OPTICAL DEVICE

(71) Applicant: MELLANOX TECHNOLOGIES LTD., Yokneam (IL)

(72) Inventors: Dimitrios KALAVROUZIOTIS, Papagou (GR); Tamir SHARKAZ, Kfar Tavor (IL); Yuri BERK, Kiryat Tiv'on (IL); Elad MENTOVICH, Tel Aviv (IL)

(21) Appl. No.: 17/755,388

(22) PCT Filed: Nov. 6, 2019
(86) PCT No.: PCT/GR2019/000078

§ 371 Date: Apr. 28, 2022

(51) Int. Cl. G02B 6/42; G03F 7/00

(52) U.S. Cl. CPC G02B 6/4206; G02B 6/4228; G03F 7/0005

(57) ABSTRACT

Various embodiments provide a method for fabricating a couplable electro-optical device. In an example embodiment, the method includes fabricating at least one raw electro-optical device on a substrate; applying lens material to a working stamp; aligning the substrate and the working stamp; pressing the substrate onto the lens material until the distance between the substrate and the working stamp is a predetermined distance; and curing the lens material to form an integrated lens secured to the at least one electro-optical device on the substrate. An anti-reflective coating layer may be optionally applied on top of the molded lens. The couplable electro-optical device may be incorporated into a receiver, transmitter, and/or transceiver using passive alignment to align the couplable electro-optical device to an optical fiber.

### TECHNICAL FIELD

Various embodiments relate to an electro-optical device having a small optical window (e.g., with a diameter of less than 40 μm). Various embodiments relate to an electro-optical device having improved coupling characteristics.

### BACKGROUND

As data communication demands increase with respect to both volume and speed, the use of electro-optical devices communicating via fiber optics has become an increasingly popular communication approach. One of the key parameters of an electro-optical device to enable higher speed is the parasitic capacitance. The lower the capacitance the higher the rate possible for the same device. The capacitance of a device is set mainly by the geometry of the device following C=Aε/D where A is the device area, D is the distance between the conductive planes, and ε is the dielectric constant between them. However, decreasing the device area (A) amounts to decreasing the optical window size, which, in turn, increases the coupling loss when connecting to an optical fiber. Therefore, there is a need for more efficiently coupling of electro-optical devices having smaller optical window sizes to optical fibers.

### BRIEF SUMMARY

FIG. 1 provides a plot comparing a photodiode response as a function of lateral offset of the optical window of the photodiode to the signal source (e.g., the core of an optical fiber) for a photodiode having an optical window with a diameter of 40 μm (triangles) and for a photodiode having an optical window with a diameter of 30 μm (diamonds). As can be seen from FIG. 1, in a photodiode having an optical window with a diameter of 30 μm (or less) there is very little allowance for misalignment of the optical window with the signal source. However, as bandwidth requirements increase, the optical windows of electro-optical devices (e.g., photodiodes, vertical cavity surface emitting lasers (VCSELs), single mode VCSEL, multimode VCSEL, and/or the like) will need to decrease to allow the electro-optical devices to operate at higher speeds. (For example, when the electro-optical device is a VCSEL, a significant challenge is the coupling of a small core fiber for single mode only (having a core diameter of approximately 9 μm versus a core diameter of approximately 50 μm for a multi-mode optical fiber) where the aperture of the VCSEL emitting area has a diameter of approximately 7 μm).

Various embodiments of the present invention provide technical solutions to the technical problems regarding electro-optical device alignment arising from the decrease in optical window size of the electro-optical device. For example, various embodiments provide electro-optical devices (e.g., photodiodes, VCSELs, and/or the like) having small optical windows (e.g., with diameters less than 40 μm) that have improved coupling characteristics. For example, various embodiments provide couplable electro-optical devices (e.g., photodiodes, VCSELs, and/or the like) having an integrated lens. Various embodiments provide a receiver, transmitter, and/or transceiver comprising a couplable electro-optical device. In various embodiments, the lens is a molded lens. In various embodiments, the lens is molded with a wafer having one or more electro-optical devices disposed thereon as the carrier. For example, the lens may be molded directly onto the electro-optical device. In various embodiments, the lens is coated with an anti-reflection coating. In various embodiments, the couplable electro-optical device is a single mode VCSEL that may be coupled to an optical fiber, such as a small core optical fiber (e.g., an optical fiber with a diameter core of approximately 10 μm or less) without the use of expensive and time intensive active alignment techniques. In various embodiments, the optical fiber may be a multi-mode optical fiber or a single mode optical fiber.

According to a first aspect, a couplable electro-optical device with improved coupling characteristics is provided. In an example embodiment, the couplable electro-optical device comprises a raw electro-optical device formed on a substrate and an integrated lens that was molded onto the substrate. An optical window of the raw electro-optical device is aligned with the integrated lens. A focal point of the integrated lens is located at a modeling point of the raw electro-optical device.

In an example embodiment, the couplable electro-optical device further comprises an anti-reflective coating on an outer surface of the integrated lens. In an example embodiment, the integrated lens comprises a spacer portion and a lens portion. In an example embodiment, a depth of the spacer portion and a radius of curvature of the lens portion are determined based on a refractive index of the integrated lens and a location of the modeling point. In an example embodiment, the raw electro-optical device is a photodiode or a vertical cavity surface emitting laser (VCSEL). In an example embodiment, the raw electro-optical device has an optical window that has a diameter less than 40 μm.

According to another aspect, a method for fabricating and/or manufacturing a couplable electro-optical device with improved coupling characteristics is provided. In an example embodiment, the method comprises fabricating at least one raw electro-optical device on a substrate; applying lens material to a working stamp; aligning the substrate and the working stamp; pressing the substrate onto the lens material until the distance between the substrate and the working stamp is a predetermined distance; and curing the lens material to form an integrated lens secured to the at least one electro-optical device on the substrate.

In an example embodiment, applying lens material to the working stamp comprises using a drop dispenser. In an example embodiment, aligning the substrate and the working stamp causes an optical window of the raw electro-optical device to be aligned with the integrated lens. In an example embodiment, aligning the substrate and the working stamp causes a focus point of the integrated lens to be located at a modeling point of the raw electro-optical device. In an example embodiment, the method further comprises applying an anti-reflection coating to an outer surface of the integrated lens. In an example embodiment, the method further comprises removing the working stamp from the couplable electro-optical device. In an example embodiment, the working stamp is removed prior the application of an anti-reflective coating. In an example embodiment, the method further comprises performing a thinning and dicing operation on the substrate. In an example embodiment, the integrated lens comprises a spacer portion and a lens portion. In an example embodiment, a depth of the spacer portion and a radius of curvature of the lens portion are determined based on a refractive index of the integrated lens and a location of the modeling point. In an example embodiment, the raw electro-optical device is a photodiode or a vertical cavity surface emitting laser (VCSEL). In an example embodiment, the raw electro-optical device has an optical window with a diameter that is less than approximately 40 μm (e.g., 30 μm, 20 μm, 12 μm (e.g., in the case of a photodiode), 6 μm (e.g., in the case of a VCSEL), and/or the like). In various embodiments, the couplable electro-optical device has a coupling efficiency greater than −1.25 dB. In various embodiments, the electro-optical device has a coupling efficiency in the range of approximately −1.0 to −0.5 dB.

According to still another aspect, a receiver, transmitter, and/or transceiver is provided. In an example embodiment, the receiver, transmitter, and/or transceiver comprises a couplable electro-optical device and an optical fiber, wherein the couplable electro-optical device is coupled to the optical fiber via passive alignment. In an example embodiment, the couplable electro-optical device comprises a raw electro-optical device formed on a substrate; and an integrated lens that was molded onto the substrate. An optical window of the raw electro-optical device is aligned with the integrated lens. A focal point of the integrated lens is located at a modeling point of the raw electro-optical device.

In an example embodiment, the couplable electro-optical device is coupled to the optical fiber via an outer lens. In an example embodiment, the optical fiber has a core that has a diameter less than approximately 10 μm. In an example embodiment, the raw electro-optical device has an optical window with a diameter that is less than 40 μm.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides a plot illustrating the response of a photodiode with respect to lateral offset between the optical window of the electro-optical device and a signal source for a photodiode having an optical window with a 40 μm diameter and for another photodiode having an optical window with a 30 μm diameter;

FIG. 2 provides a schematic diagram of an electro-optical device, in accordance with an example embodiment;

FIG. 3 provides a schematic diagram showing coupling of an electro-optical device to an optical fiber, in accordance with an example embodiment;

FIG. 4 provides a flowchart showing various processes, procedures, and/or operations for fabricating and/or manufacturing an electro-optical device, in accordance with an example embodiment;

FIGS. 5A-5E illustrate various steps of fabricating and/or manufacturing an electro-optical device, in accordance with an example embodiment;

FIGS. 6A, 6B, and 6C illustrate an example embodiment of alignment marks that may be used on the working stamp and the substrate to aid in the alignment thereof;

FIG. 7 provides a schematic diagram of a receiver, transmitter, and/or transceiver comprising a couplable electro-optical device, in accordance with an example embodiment; and

FIG. 8 provides a plot illustrating simulation results of the coupling efficiency of a fiber to a photodiode with an integrated lens (circles), where the integrated lens has a radius of curvature of R=26 μm, and without an integrated lens (squares) as a function of the diameter of the optical window of the photodiode.

### DETAILED DESCRIPTION OF THE INVENTION

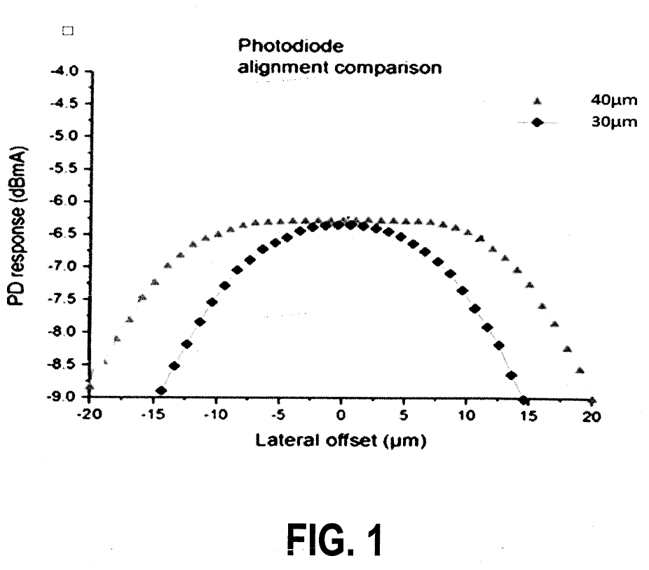

FIG. 1 provides a plot comparing a photodiode response as a function of lateral offset of the optical window of the photodiode to the signal source (e.g., the core of an optical fiber) for a photodiode having an optical window with a diameter of 40 μm (triangles) and for a photodiode having an optical window with a diameter of 30 μm (diamonds). As can be seen from FIG. 1, for a photodiode having an optical window with a diameter of 30 μm (or less) there is very little allowance for misalignment of the optical window with the signal source. However, as bandwidth requirements increase, the optical windows of electro-optical devices (e.g., photodiodes, vertical cavity surface emitting lasers (VCSELs), and/or the like) will need to decrease to allow the electro-optical devices to operate at higher speeds.

Various embodiments of the present invention provide technical solutions to the technical problems regarding electro-optical device alignment arising from the decrease in optical window size of the electro-optical device. For example, various embodiments provide electro-optical devices (e.g., photodiodes, VCSELs, and/or the like) having small optical windows (e.g., with diameters less than 40 μm) that have improved coupling characteristics. For example, various embodiments provide couplable electro-optical devices (e.g., photodiodes, VCSELs, and/or the like) having an integrated lens. In various embodiments, the lens is a molded lens. In various embodiments, the lens is molded with a wafer having one or more electro-optical devices disposed thereon as the carrier. For example, the lens may be molded directly onto the electro-optical device. In various embodiments, the lens is coated with an anti-reflection coating.

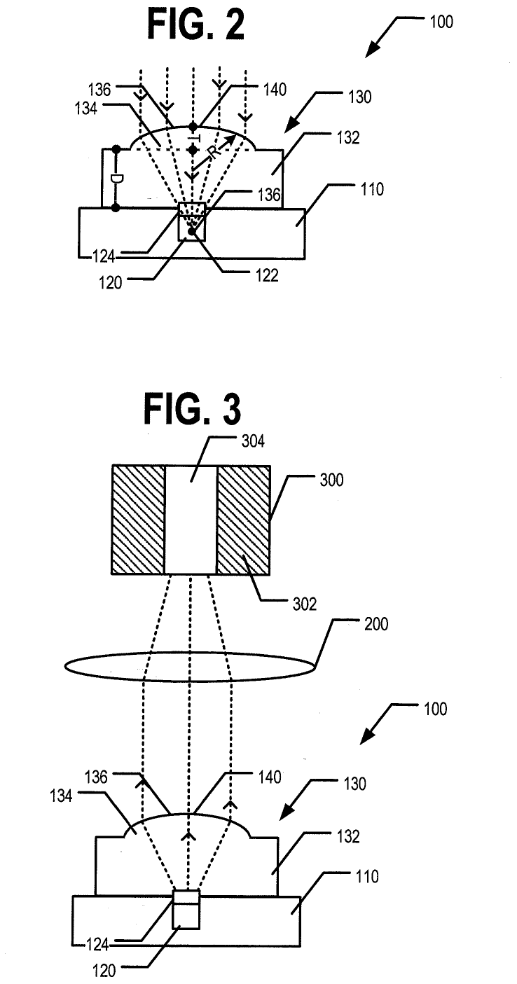

FIGS. 2 and 3 provide schematic diagrams of couplable electro-optical devices 100 having improved coupling characteristics, in accordance with example embodiments. In various embodiments, the couplable electro-optical device 100 has improved coupling characteristics compared to the raw electro-optical device 120. In various embodiments, a couplable electro-optical device 100 comprises a raw electro-optical device 120 formed and/or fabricated on a substrate 110. In various embodiments, the substrate 110 is a wafer. For example, two or more raw electro-optical devices 120 may be formed and/or fabricated on the substrate 110. In various embodiments, the raw electro-optical device 120 comprises an optical window 124. In various embodiments, the optical window 124 is a small optical window. For example, the optical window 124 has a diameter less than approximately 40 μm (e.g., 30 μm, 20 μm, 12 μm (e.g., in the case of a photodiode), 6 μm (e.g., in the case of VCSEL) and/or the like). In various embodiments, the raw electro-optical device 120 is a photodiode, VCSEL, or other electro-optical device.

In an example embodiment, the raw electro-optical device 120 comprises an active area. For example, when the raw electro-optical device 120 is a photodiode or other receiving device, the active area is the surface/location at which signal detection occurs. In another example, when the raw electro-optical device 120 is a VCSEL or other emitting device, the active area is the surface/location from which the light is emitted. In various embodiments, a modeling point 122 may be used to model the active area of the raw electro-optical device 120 as a point. For example, when the focal point 136 of the integrated lens 130 is located at the modeling point 122 of the raw electro-optical device 120, a beam incident on the active region of the raw electro-optical device 120 via the integrated lens 130 will have a beam width such that a significant portion of the beam (e.g., the central portion of the beam within the full width half maximum radius of the beam) incident on the optimal portion of the active area for signal detection. In another example, when the focal point 136 of the integrated lens 130 is located at the modeling point 122 of the raw electro-optical device 120, a beam emitted from the active region and incident on the integrated lens 130 will be emitted from the couplable electro-optical device 100 with an approximately constant beam width (e.g., the beam may be modeled by approximately and/or substantially parallel rays).

In various embodiments, the couplable electro-optical device 100 comprises an integrated lens 130. In various embodiments, the integrated lens comprises a lens portion 134 and a spacer portion 132. In an example embodiment, the lens portion 134 has a radius of curvature R and a thickness T, and the spacer portion 132 has a depth D such that the focal point 136 of the integrated lens 130 is coincident with the modeling point 122. As should be understood by one skilled in the art in light of this disclosure, the radius of curvature R and the depth D are determined based on the modeling point 122 and the refractive index n of the material of the integrated lens 130. In various embodiments, the integrated lens 130 is a molded lens. In various embodiments, the integrated lens 130 is molded onto the raw electro-optical device 120 and/or the substrate 110. In various embodiments, the integrated lens 130 is a molded micro-lens.

In various embodiments, the depth D is in the range of approximately 0.03 mm to 0.05 mm. In various embodiments, the depth D is in the range of approximately 0.035 mm to 0.045 mm. In an example embodiment, the depth D is approximately 0.4 mm. In various embodiments, the radius of curvature R is in the range of approximately 20 to 35 μm. In various embodiments, the radius of curvature R is in the range of approximately 25-30 μm. For example, the radius of curvature R may be in the range of approximately 26-28 μm. In various embodiments, the thickness T is in the range of approximately 5-25 μm. In various embodiments, the thickness T is in the range of approximately 8-16 μm. In an example embodiment, the thickness T is in the range of approximately 10-14 μm.

In various embodiments, the integrated lens 130 is made of a lens material selected for a combination of the mechanical and optical properties of the material. In an example embodiment, the integrated lens 130 is made of a lens material that is a polymeric material. In an example embodiment, the lens material is a cured polymeric material. In an example embodiment, curing the polymeric material to provide the lens material includes heating the polymeric material and/or exposing the polymeric material to UV light. In an example embodiment, the lens material is a polymeric material that requires heat and/or UV curing. For example, the lens material may be a liquid resin that when cured becomes a solid polymeric material. In an example embodiment, the lens material is a hybrid inorganic-organic polymeric material. In various embodiments, the cured lens material has a refractive index n in the range of approximately 1.2 to 1.9. In an example embodiment, the cured lens material has a refractive index n in the range of approximately 1.4 to 1.6. For example, in an example embodiment, the cured lens material has a refractive index n in the range of approximately 1.50 to 1.55. In various embodiments, the cured lens material has a refractive index n in the range of approximately 1.50 to 1.55 in the wavelength range 400-1600 nm. In various embodiments, the cured lens material has a refractive index n in the range of approximately 1.50 to 1.52 in the wavelength range of 700-1600 nm.

In various embodiments, the integrated lens 130 comprises an anti-reflective coating 140. For example, the outer surface 136 of the integrated lens 130 may be the surface of the integrated lens 130 that faces away from the raw electro-optical device 120. In various embodiments, the outer surface 136 of the integrated lens 130 may have an anti-reflective coating 140 thereon. In various embodiments, the anti-reflective coating 140 may be selected based on the wavelength of light that the raw electro-optical device 120 is configured to receive/detect and/or emit. In an example embodiment, the thickness of the anti-reflective coating 140 is selected based on the wavelength of light that the raw electro-optical device 120 is configured to receive and/or emit.

In various embodiments, the couplable electro-optical device 100 may be coupled to an optical fiber 300. In various embodiments, the couplable electro-optical device 100 is coupled to the optical fiber 300 without the use of active alignment. In various embodiments, the couplable electro-optical device 100 is coupled to the optical fiber 300 via an outer lens 200. In an example embodiment, the optical fiber 300 is a small core optical fiber. For example, the optical fiber 300 may comprise an outer fiber cladding 302 and an optical fiber core 304. In an example embodiment, the optical fiber core 304 has a diameter of approximately 9 μm. For example, the optical fiber core 304 may have a diameter less than 15 μm. For example, the integrated lens 130 may condition the light emitted by the raw electro-optical device 120 (e.g., a VCSEL) such that the light emitted by the couplable electro-optical device 100 is described by a set of substantially parallel rays. The outer lens 200 may then be used to focus the light emitted by the couplable electro-optical device 100 into the core of the optical fiber 300. Thus, the couplable electro-optical device 100 may be efficiently coupled to a small core optical fiber 300 (e.g., having a core 304 diameter of approximately 10 μm or less) without the use of expensive and time intensive active alignment techniques. Rather, a static outer lens 200 may be employed to focus the light emitted by the couplable electro-optical device 100 onto the core 304 of the optical fiber 300 for an efficient coupling.

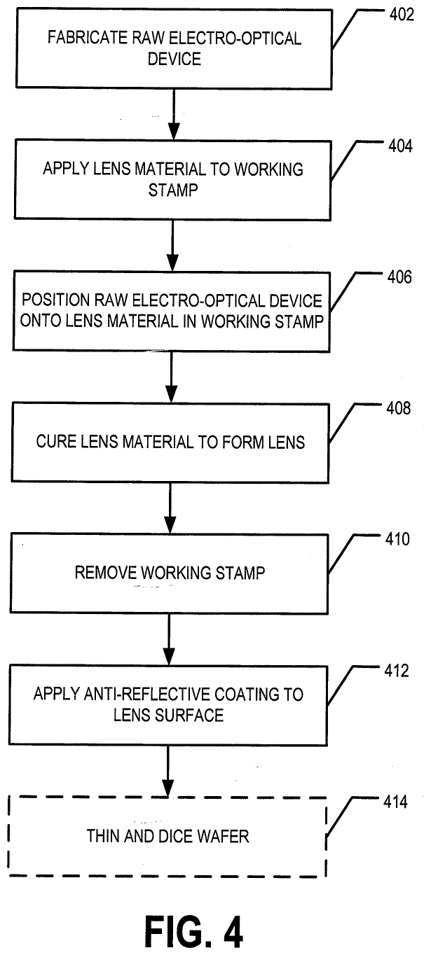

FIG. 4 provides a flowchart describing various processes, procedures, operations, and/or the like for fabricating a couplable electro-optical device 100, in accordance with an example embodiment. Starting at block 402, the raw electro-optical device 120 is fabricated on the substrate 110. In an example embodiment, a plurality (e.g., two or more, possibly 40,000-80,000) raw electro-optical devices 120 are fabricated on the same substrate 110 (e.g., on a wafer). For example, one or more photodiodes may be fabricated on the substrate 110. In another example, one or more VCSELs may be fabricated on the substrate 110.

At block 404, the lens material is applied to a working stamp. In various embodiments, the working stamp is manufactured and/or fabricated using a very accurate photolithography-based process to assure accurate alignment between the raw electro-optical devices populated and/or fabricated on the substrate 110 (e.g., on a wafer) and the resulting integrated lenses 130. In an example embodiment, the lens material applied to the working stamp using a droplet dispenser. For example, a droplet dispenser may dispense the lens material drop by drop into/onto the working stamp. In an example embodiment, the droplet dispenser is used to apply the lens material to the working stamp so that when the raw electro-optical device 120 is pressed onto the lens material within the working stamp, the lens material does not cover the leads of the raw electro-optical device 120 and/or the space between raw electro-optical devices on the substrate 110 that is intended for use during thinning and dicing procedures and/or during wire bonding while assembling the couplable electro-optical device 100 onto an optical cable (e.g., active optical cable (AOC)), transceiver, and/or the like, later in the couplable electro-optical device 120 fabrication and/or assembly process.

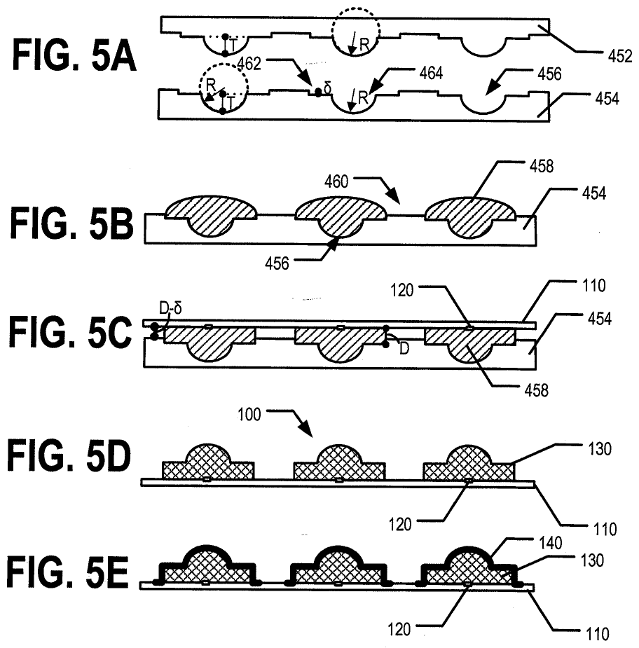

FIG. 5A shows cross-sections of an example master stamp 452 and an example working stamp 454 made using the master stamp 452. For example, the master stamp 452 may be designed based on the separation between raw electro-optical devices 120 on the substrate 110, the location of the modeling point 122 within the raw electro-optical device 120, the optical properties of the cured lens material, and/or the like. In various embodiments, a master stamp 452 may be used to make a plurality of working stamps 454. For example, the master stamp 452 may define the radius of curvature R and thickness T of the integrated lens 130 to be molded onto the raw electro-optical device 120 to form the couplable electro-optical device 100.

The master stamp 452 may be used to make or form the working stamp 454. For example, the working stamp 454 may be a negative of the integrated lens 130. For example, the working stamp 454 may comprise one or more molds 456 for receiving and molding lens material into integrated lenses 130. Each mold 456 may comprise a well comprising a lens mold portion 464 having a radius of curvature R and a thickness T, and a spacer mold portion 462 having a depth 8. For example, the lens mold portion 464 may be a curved surface that approximates and/or is a portion of a sphere, as shown by the dashed circle in FIG. 5A. The radius of curvature R is be the radius of that sphere. The thickness T is the sagitta or height of the spherical segment of the lens mold portion 464. In other words, the thickness T is the length that the lens portion 134 extends beyond the spacer portion 132 of the integrated lens 130. In an example embodiment, the working stamp 454 maybe made of glass, silicon, and/or other appropriate material. In various embodiments, an appropriate material has a very smooth surface and very clean detachment properties in order to ensure high optical grade integrated lenses 130.

FIG. 5B shows a cross-section of a working stamp 454 that has had lens material 458 deposited into the molds 456. For example, the lens material 458 may have been applied and/or deposited into the molds 456 drop by drop by a droplet dispenser. As shown in FIG. 5B, lens material 458 is not disposed in the spaces 460 between the molds 456, in an example embodiment. In various embodiments, a working stamp 454 may be used to fabricate integrated lenses 130 for a plurality (e.g., 50) substrates 110 (e.g., wafers).

Continuing with block 406 of FIG. 4, raw electro-optical devices 120 are positioned onto the lens material 458 in the working stamp 454. In various embodiments, a very accurate photolithography alignment technique is used to align the raw electro-optical devices 120 on the substrate 110 onto the lens material 458 in the working stamp 454 to ensure an accurate alignment between the raw electro-optical device 120 and the resulting molded lens (e.g., the integrated lens 130). For example, the substrate 110 (e.g., a wafer) may comprise a first set of alignment marks and the working stamp 454 may comprise a second set of alignment marks. In an example embodiment, the first set of alignment marks and/or the second set of alignment marks may comprise metallic patterns having smooth edges disposed on the substrate 110 or the working stamp 454, respectively. An alignment tool (e.g., a photolithography alignment tool) may then be used to appropriately align the first and second sets of alignment marks.

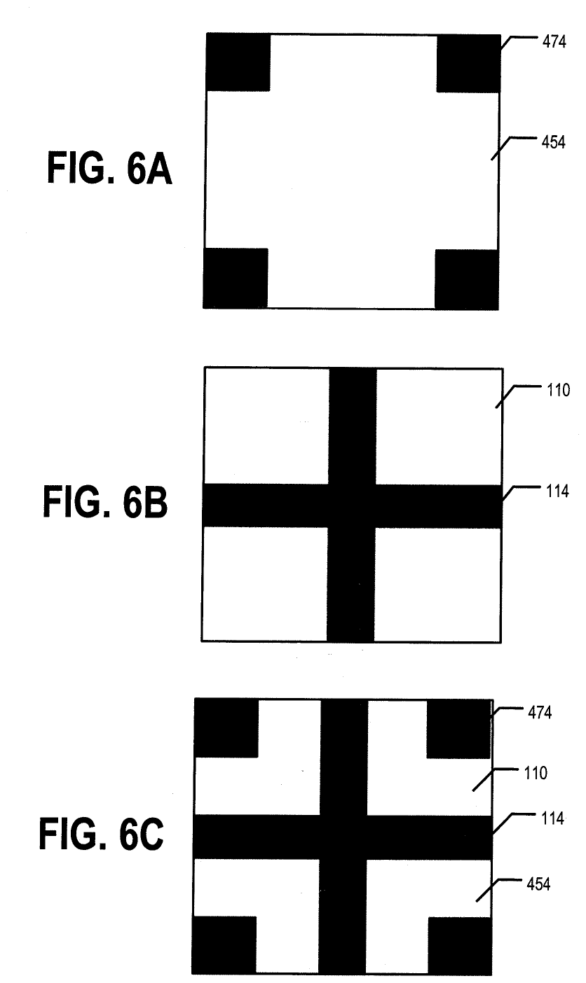

For example, in an example embodiment, the first set of alignment marks 114 comprises a plus sign disposed on the substrate 110, as shown in FIG. 6B, and the second set of alignment marks 474 may comprise a mark (e.g., dot, square, rectangle, and/or other mark) disposed in each corner of the working stamp 454, as shown in FIG. 6A. FIG. 6C illustrates how the first set of alignment marks 114 and the second set of alignment marks 474 may be used to align the working stamp 454 and the substrate 110 (e.g., wafer). In an example embodiment, the second set of alignment marks are disposed on a side of the working stamp 454 configured to receive the lens material 458. In this example, the substrate 110 and the working stamp 454 may be aligned by centering each arm of the plus sign between a pair of marks on the working stamp 454. In various embodiments, the alignment process results in a projection of the center of the optical window of the raw electro-optical device being disposed less than 3 μm (e.g., 2 μm or less) from a projection of the center of the integrated lens 130, when the center of the optical window and the center of the integrated lens 130 are projected into a plane that is substantially parallel to the substrate 110.

For example, the raw electro-optical devices 120 on the substrate 110 (e.g., wafer) may be positioned onto the lens material 458 in the working stamp 454. For example, the substrate 110 may be aligned with the working stamp 454 and then the substrate 110 may be pressed onto the lens material 458 within the working stamp 454 until the distance between the substrate and the working stamp is a predetermined distance. In various embodiments, the predetermined distance (e.g., the distance between the substrate 110 and the working stamp 454) is D−δ, such that the resulting spacer portions 132 will have a depth D. FIG. 5C shows a cross-section of the substrate 110 having raw electro-optical devices 120 formed thereon pressed onto the lens material 458 within the working stamp 454. For example, aligning the substrate 110 with the working stamp 454 may cause the optical windows 124 of each of the raw electro-optical devices 120 formed on the substrate 110 to be properly aligned with the corresponding molds 456 of the working stamp 454. Thus, the optical windows of the resulting couplable electro-optical devices 100 will be appropriately aligned with the corresponding integrated lenses 130. Therefore, aligning the substrate 110 with the working stamp 454, which may be relatively easy and reproducible, may eliminate the need to perform active alignment procedures later.

Continuing with FIG. 4, at block 408, the lens material 458 is cured to form the integrated lens 130. For example, the lens material 458 may be cured via UV exposure, heating (e.g., hard baking), and/or the like. In an example embodiment, the lens material 458 is cured via heating. In an example embodiment, the heating of the lens material 458 includes heating the lens material 458 to a temperature in the range of approximately 100-250° C. In an example embodiment, the lens material 458 is cured via UV exposure. In an example embodiment, the lens material 458 is cured via a combination of UV exposure and heating. In an example embodiment, heating the lens material 458 includes heating the lens material 458 to a temperature in the range of approximately 150-180° C. In various embodiments, the lens material 458 is chosen such the curing requirements of the lens material 458 will not negatively affect the raw electro-optical device 120. In various embodiments, the lens material 458 is cured onto the substrate 110, such that the substrate 110 acts as a carrier for the integrated lenses 130. For example, curing the lens material 458 onto the substrate 110 may cause the integrated lenses 130 to be secured to the substrate 110. At block 410, the working stamp 454 is removed from the couplable electro-optical devices 100. For example, the couplable electro-optical devices 100 may be de-touched from the working stamp 454. FIG. 5D illustrates the couplable electro-optical devices 100 on the substrate 110 after the curing of the lens material 458 and the removal of the working stamp 454.

At block 412 of FIG. 4, an anti-reflective coating 140 is applied to the outer surface 136 of the integrated lens 130. The anti-reflective coating 140 may be allowed to dry, be cured, and/or the like. In an example embodiment, the thickness of the anti-reflective coating 140 is determined based on the wavelength and/or wavelength band at which the couplable electro-optical device 100 is configured to operate (e.g., detect and/or transmit). FIG. 5E illustrates the couplable electro-optical devices 100 on the substrate 100 that have had an anti-reflective coating 140 applied to the outer surface 136 of the integrated lens 130. In various embodiments, the anti-reflective coating is configured to prevent light from reflecting off of the outer surface 136 of the integrated lens 130 and contaminating light being received from and/or provided to the optical fiber 300.

Continuing with FIG. 4, at block 414, the couplable electro-optical devices 100 may be tested and the substrate 110 (e.g., wafer) may be thinned and diced. For example, the substrate 110 may be cut so that each electro-optical device 100 formed thereon may be incorporated into various devices independently. For example, a couplable electro-optical device 100 may be incorporated into a receiver, transmitter, and/or transceiver. For example, a couplable electro-optical device 100 may be incorporated into a receiver, transmitter, and/or transceiver using passive alignment techniques for aligning the couplable electro-optical device 100 with an optical fiber 300 or other waveguide. For example, a couplable electro-optical device 100 may be incorporated into a receiver, transmitter, and/or transceiver using a static outer lens 200 to passively align the couplable electro-optical device 100 to an optical fiber 300 or other waveguide.

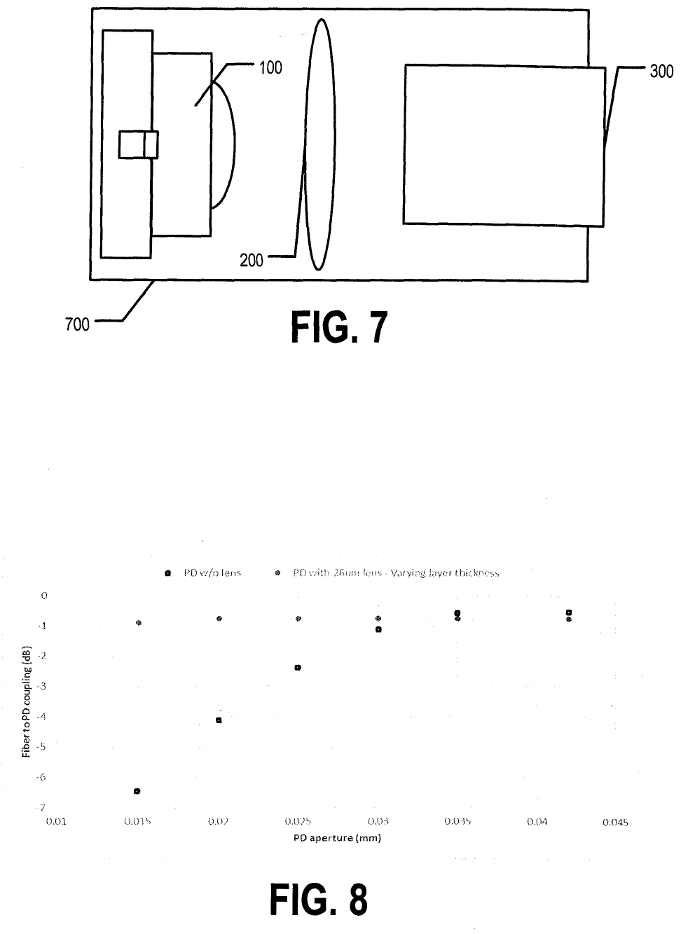

For example, FIG. 7 provides an example schematic diagram of a receiver, transmitter, and/or transceiver 700 comprising a couplable electro-optical device 100. For example, the receiver, transmitter, and/or transceiver 700 may comprise an optical fiber 300. In various embodiments, the couplable electro-optical device 100 is coupled to the optical fiber 300 using passive alignment. For example, the couplable electro-optical device 100 may be coupled to the optical fiber 300 via outer lens 200. In various embodiments, one or more outer lenses 200 may be used to passively align the couplable electro-optical device 100 to the optical fiber 300 in an efficient coupling. In various embodiments, the raw electro-optical device 120 of the couplable electro-optical device 100 has an optical window that has a diameter less than approximately 40 μm (e.g., 30 μm, 20 μm, and/or the like). In an example embodiment, the optical fiber 300 has a core 304 that has a diameter of less than approximately 10 μm.

As shown in FIG. 8, a couplable electro-optical device 100 (see the circles) having an optical window with a diameter of less than 30 μm has significantly better coupling characteristics than a raw electro-optical device 120 (see the squares) having an optical window with a diameter of less than 30 μm.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for fabricating a couplable electro-optical device, the method comprising:
fabricating a raw electro-optical device on a substrate;
applying lens material to a working stamp;
aligning the substrate and the working stamp;
pressing the substrate onto the lens material until the distance between the substrate and the working stamp is a predetermined distance; and
curing the lens material to form an integrated lens secured to the raw electro-optical device on the substrate.

2. The method of claim 1, further comprising fabricating the working stamp from a master stamp.

3. The method of claim 1, wherein applying lens material to the working stamp comprises using a drop dispenser.

4. The method of claim 1, wherein aligning the substrate and the working stamp causes an optical window of the raw electro-optical device to be aligned with the integrated lens.

5. The method of claim 1, wherein aligning the substrate and the working stamp causes a focus point of the integrated lens to be located at a theoretical modeling point corresponding to an active area of the raw electro-optical device.

6. The method of claim 1, further comprising applying an anti-reflection coating to an outer surface of the integrated lens.

7. The method of claim 1, further comprising removing the working stamp from the couplable electro-optical device.

8. The method of claim 1, wherein aligning the working stamp and the substrate comprises using a photolithography-based process.

9. The method of claim 1, wherein (a) the integrated lens comprises a spacer portion and a lens portion, (b) a depth of the spacer portion and a radius of curvature of the lens portion are determined based on a refractive index of the integrated lens and a location of a theoretical modeling point corresponding to an active region of the raw electro-optical device.

10. The method of claim 1, wherein the raw electro-optical device is a photodiode or a vertical cavity surface emitting laser (VCSEL).

11. A couplable electro-optical device comprising:
a raw electro-optical device formed on a substrate; and
an integrated lens molded onto the substrate,
wherein (a) an optical window of the raw electro-optical device is aligned with the integrated lens and (b) a focal point of the integrated lens is located at a theoretical modeling point corresponding to the active area of the raw electro-optical device.

12. The couplable electro-optical device of claim 11, further comprising an anti-reflective coating on an outer surface of the integrated lens.

13. The couplable electro-optical device of claim 11, wherein the integrated lens comprises a spacer portion and a lens portion.

14. The couplable electro-optical device of claim 13, wherein a depth of the spacer portion and a radius of curvature of the lens portion are determined based on a refractive index of the integrated lens and a location of the modeling point.

15. The couplable electro-optical device of claim 11, wherein the raw electro-optical device is a photodiode or a vertical cavity surface emitting laser (VCSEL).

16. The couplable electro-optical device of claim 11, wherein the raw electro-optical device has an optical window with a diameter that is less than 40 μm.

17. A receiver, transmitter, or transceiver comprising:
a couplable electro-optical device comprising:
a raw electro-optical device formed on a substrate; and
an integrated lens molded onto the substrate; and
an optical fiber,
wherein (a) an optical window of the raw electro-optical device is aligned with the integrated lens and (b) a focal point of the integrated lens is located at a theoretical modeling point corresponding to an active area of the raw electro-optical device, and
wherein the couplable electro-optical device is coupled to the optical fiber via passive alignment.

18. The receiver, transmitter, or transceiver of claim 17, wherein the couplable electro-optical device is coupled to the optical fiber via an outer lens.

19. The receiver, transmitter, or transceiver of claim 17, wherein the optical fiber has a core that has a diameter of approximately 50 μm or less.

20. The receiver, transmitter, or transceiver of claim 17, wherein the raw electro-optical device has an optical window with a diameter that is less than 40 μm.
